(19) United States
(12) Patent Application Publication
(10) Pub. No.: US 2011/0307185 A1
(43) Pub. Date: Dec. 15, 2011

(54) DYNAMIC SYSTEM OF INSTANTANEOUS COUNTING AND CUMULATIVE PERIODIC SPACE-TIME RECORD OF EQUIVALENT CARBON DIOXIDE EMISSIONS

(76) Inventors: GAIOLI FABIAN HORACIO, Ciudad Autonoma De Buenos Aires (AR); VENTUREIRA HUGO BERNARDO, Ciudad Autonoma De Buenos Aires (AR); LEBAS GABRIEL OMAR, Ciudad Autonoma De Buenos Aires (AR); DURSO ROBERTO OMAR, La Plata (AR)

(21) Appl. No.: 13/158,001

(22) Filed: Jun. 10, 2011

(30) Foreign Application Priority Data
Jun. 15, 2010 (AR) 20100102119

(51) Int. Cl. G06F 19/00

(52) U.S. Cl. 702/22

(57) ABSTRACT

A dynamic system of counting and cumulative periodic space-time record of equivalent carbon dioxide emissions is revealed, which collects energy consumption data from conventional measuring systems of each installation, adapts and transmits them to a multi-transducer, whose processor, by means of a software, calculates carbon dioxide equivalent emissions related to that consumption. The signals processed are transmitted to interfaces which generate instant or cumulative digital data, as well as to a remote recording and processing central.

### CROSS REFERENCE TO RELATED APPLICATION

This application claims priority to ARGENTINA application 20100102119, filed Jun. 15, 2010. The foregoing application is incorporated herein by reference, in its entirety.

### INTRODUCTION

The present invention consists of a dynamic system of instantaneous counting and cumulative periodic space-time record of equivalent carbon dioxide emissions, from fixed or mobile sources, which can be used for any type of installation which uses an energy resource that may give rise to the combustion of fossil fuels either directly (liquid, solid, gaseous fuels, etc. in thermal equipments, internal combustion engines, etc.) or indirectly (electricity), regardless of the energy resource used (whether they are liquid, solid, gaseous fuels, electricity, etc.), and which also allows to publish the counting of the equivalent carbon dioxide emissions (CO₂e) resulting from energy consumption, either immediately or periodically, in a digital or analogue way, locally or in a decentralised way, publicly and/or privately. Each consumption measured (measurement) shall be transformed into a CO₂e value by means of an emission factor (conversion). This record shall be characterized by the type of installation, the energy resource used, the measurement timing (synchronization) and site (location), the number of units demanding the energy resource (identification) and the amount of CO₂e emitted, and shall be stored in a database (registration) for its processing and subsequent publication and diffusion (communication) of aggregate or broken down information according to the sector data required (integration). Besides, in the case of a systemic application in a vertical segment of a broken down component of the National Energy Balance corresponding to the final energy consumption (Residential, Commercial and Public, Transport, Agriculture and Industry), this last characteristic would allow to obtain the final energy consumption in that segment more accurately. Additionally, the current invention embodies the simultaneous identification of the agent (individual or collective) demanding the consumption of the energy resource, so as to distribute the registered CO₂e emissions as a unit. For instance, in the case of vehicles or homes the number of individuals shall be registered; as regards freight the load transported shall be registered; in an industrial installation, the amount of products coming from a production line or process unit, in case of air transport, the number of passengers, etc. This report reveals a dynamic system of counting and record of equivalent carbon dioxide emissions, formed by a multi-transducer working as interface and transferring data to a hardware device, in which a software application calculates the CO₂e emission resulting from energy consumption, which in turn can be transmitted to a remote database and/or be stored in a memory of the system placed in the site demanding the energy resource and that is the source of CO₂e emissions. The multi-transducer devices, hardware and software required for the calculation, as well as the visual interface devices required for its visualization and analysis (screens, clocks, etc.) can be incorporated to the meters and recorders of the energy resource used, or can be designed independently according to the use aimed to give to the data obtained. In order to understand the current invention so that it can be put into practice easily, the following paragraphs contain a precise description of a preferred embodiment, making reference to the illustrative drawings hereto attached, only as a purely demonstrative example of the invention but not restricted to it, whose components can be chosen among different equivalent elements while keeping the principles of the invention set forth in this documentation.

### STATE OF THE ART

It is universally well-known the concern caused by the excessive emissions of gases called “greenhouse gases”, among which the main one is carbon dioxide or CO₂. The serious consequences for climate caused by this excess of gas emissions encouraged the main countries in the world to initiate or commit to initiate policies for emission reduction on a large scale. However, this good intention faces the obstacle of emission measurement methods which are incomplete and inaccurate, and therefore unreliable to define appropriate policies reaching people and able to lead to the change of behaviour that is needed to reduce the current consumption patterns. Among these defects we can mainly point out that they are indirect measurement methods. In some cases, periodic samples are taken into account in order to make emission estimates, with the usual margin of error this may entail. Sometimes lab tests are performed on a specific product to determine, for instance, the emissions that will be emitted (on average use) by a new car model. However, the type of fuel used, the gradual engine wear, the frequency and way in which the vehicle is used, the poor maintenance and many other variables will turn that ideal equation into a very different reality that nobody is nowadays able to estimate. The same applies to the estimated emissions for the products transportation, which are currently calculated considering supposed kilometres from the production site to that of consumption, and not by means of methods related to consumption and hence, real emissions. Household appliances are classified into categories A, B, C, D, E according to a consumption efficiency level that turns to be theoretical, since it is not monitored. The lack of direct data, current and permanent, causes the overall system of actual emission calculation to be limited to values aggregated to a scale that includes large groups of end users (national data, sector records, etc.). Secondly, these are static methods since, in the absence of instant data allowing to finding out permanent variations in consumption, sampling measurements are used and they are mere estimates. Thirdly, a general data analysis is made to deduce particular data (“top-down” methodology), since they do not rely on data breakdown available, without the possibility of including the individual on the accounting, which shows inaccurate and incomplete results, and leaves little room to articulate public and/or private improvement policies, savings and emission reductions. Finally, these are methods which do not allow the access to own and particular emission data and prevent us from knowing the contribution of each group (family, neighbourhood, business) and from generating an own conscious reduction policy. The proposed invention aims to solve these problems in order to obtain a more accurate measurement, direct or indirect, of CO₂e emissions at individual level (“bottom-up” methodology). Therefore a counting method is proposed, taking actual data permanently and currently, allowing its analysis at the precise moment the emissions occur. It is also a dynamic method since data can be obtained at all Limes allowing to count consumption fluctuations or gas emissions of the unit measured (vehicle, home, factory, etc.) in specific periods of time (different times of the day or year) in order to settle the best reduction policy for each particular case. Besides, since the starting point is the measurement of particular data (“bottom-up” methodology) to reach general conclusions, it has a much higher degree of accuracy, reaching the highest degree of data breakdown. Certainly, another unavoidable advantage of the proposed invention is that, since it is a particular measurement, with results that can be permanently accessed by the people involved in the gas emission process, it creates a remarkable awareness of the problem and allows to deal with it in the daily reality, being able to monitor the results obtained when a particular reduction policy is applied. The proposed invention seeks a simple, fast and effective solution to make precise and permanent emission counts, whether they belong to the industrial, home or transportation sector, obtaining immediate and dated results, thus providing a reliable and immediate information so as to take decisions at government level (as from the particular data obtained that can be accumulated and transmitted at any government level) as well as private level (as from the control of data belonging to every installation measured).

### OBJECTIVE

The proposed solution has several specific objectives that are detailed below: a) Obtain precise data in order to outline the application of public polices to reduce greenhouse gas emissions, at industrial level as well as, for instance, in passengers and/or freight public transport, taxi and/or remises fleets, residential electricity consumption, etc, b) Promote awareness of the problem of greenhouse gas emissions in general population, starting from the diffusion of this information, which is placed “ at sight” of the users, with permanent objective data on their own influence on this matter, so that beyond state policies, people learn to self-control emissions. c) Offer emitting companies objective data enabling them to set up policies of greenhouse gas emission reduction to distinguish themselves from other companies due to their commitment with the environment in the framework of their social enterprise responsibility. The system is able to be adapted to a great number of applications, among which the main ones are the following: 1) Planes, trucks, buses, vans and cars and any other type of vehicle or mobile device producing greenhouse gas emissions (farm equipment, boats, etc.). In this case, the fuel consumption data is obtained from the device installed for that purpose, according to the type and amount of fuel consumed and/or according to the kilometres travelled, related to the average speed of each section, and by means of the mathematical algorithm applied in each case, it is translated into the language of the system developed to make the mathematical calculation and, with the CO₂e data generated, it is transmitted to two displays in the vehicle, one recording data in a permanent and chronological way and another one which is able to accumulate by sections, since it has a storing memory for the data chronologically recorded. Likewise, data accumulated in both displays can be transmitted through a communication protocol, previously agreed, to a centralized database, in which such information shall be managed through a specific program. In parallel, passengers or load transported data is taken by the use of people detectors or scales and it is incorporated to the CO₂e register. 2) Homes, repair shops, factories, offices, etc.: In this case the data of electric energy consumption and consumption of gas or any other fossil fuel is taken from the corresponding meter installed to that effect and, by placing a device on a control board, whether it is integrated or not to the electric energy meter or fuel gauge of a site, it is translated to the language of the system developed by means of the mathematical algorithm to be applied in each case so that, with the CO² generated data, it is transmitted to two displays in the house, repair shop, office, etc.; one of them records in a permanent and chronological way and the other one is able to accumulate by sections since it has a storing memory for the data chronologically recorded. This information may also be transmitted, continuously or at random, to a database for its administration. At the same time, the data of people present or the amount of product produced is taken by the use of people detectors or control boards of the daily production reports, and incorporated to the CO₂e register. 3) Machinery, equipments, boners, household appliances, etc.: in this case the data of electric energy consumption is taken from the corresponding meter installed to that effect, and is translated to the language of the system developed to make the mathematical calculation and, with the CO₂e data generated, it is transmitted to two displays as the ones already described, being able to be transmitted as mentioned above. In parallel, the data of the energy produced as heat, mechanical energy, etc. is taken from control devices in the equipments and it is incorporated to the CO₂e register.

### BRIEF DESCRIPTION OF THE DRAWINGS

Find attached to this presentation a figure whose outstanding features are described below.

FIG. 1) Reference A1) shows the meter of the energy resource installed or matched in the equipment measured (flow meter for gases or liquids, home gas or electricity meters, fuel instant consumption meter for vehicles, etc.) and reference A2) shows the detector of units demanding the energy resource (people, product, load, etc.). The dotted box indicates the multi-transducer device. Reference B1) shows an incoming module of the multi-transducer which filters analogue input signals and B2) shows a module that filters the digital signals in order to protect the entire system. Reference B3) indicates the filter for the incoming input signal coming from the detector units demanding the energy resource. Reference C) indicates the multi-transducer block that processes and translates the input signals to send them to the processor once adapted and unified. Reference D) indicates the processor managing and directing the incoming signal to each output, which contains the program or software that calculates, apart from other parameters, the CO₂e emissions. Da) indicates the universal clock that allows the chronological correlation of the measurements and Db) indicates the necessary memory for the accumulation of data. Reference E1) shows the output filter for the end devices for the CO₂e visualization record and E2) indicates an output filter for the communication port and the source transmitting and receiving information to/from devices that will afterwards send/receive data through system and conventional radio-navigation protocol (e.g. GPS, mobile telephone, etc.). Reference F1) shows the interfaces that may be a board, screen, clock, etc. providing instant information and F2) shows the ones providing cumulative information. Reference F3) shows the output communication port that allows the registrar to make settings and allows the transmission of each record to a remote processing central referenced as F4)

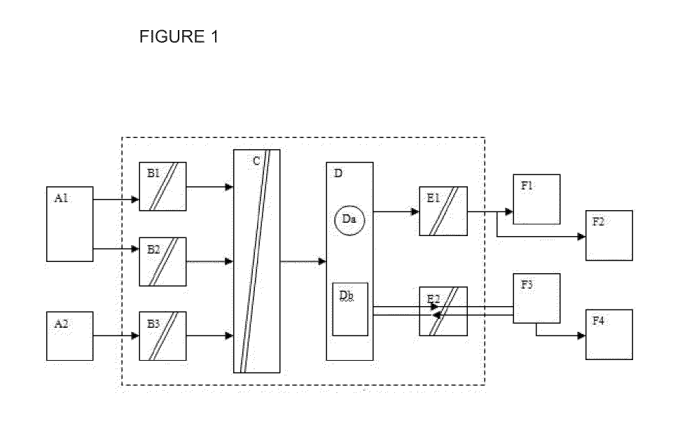

### DESCRIPTION OF THE INVENTION

The proposed dynamic system of instant counting and cumulative periodical space-time record equivalent carbon dioxide emissions works on the basis of the following scheme and components. In each case the consumption of the energy resource used and the units demanding that resource are taken as incoming data and, by means of a multi-transducer working as an interface, that data is transferred to a hardware device in which a software application calculates the single CO₂e emission related to that consumption. Multi-transducer devices, hardware and software required for the calculation, as well as the required visual interface devices (displays, clocks, etc.), can be incorporated to the meters and recorders of the energy resource used, or they can be designed independently, according to the use aimed to give to the data obtained. It starts with the measurement of consumption of the energy resources appropriate. That measurement is made by conventional devices already installed on the equipments (e.g. flow meter for measuring gas consumption or fuel oil in a boner), meters (e.g. for home gas or electricity to households with direct reading), vehicles (combination of flow meter with the fuel tank float with direct reading of the instant fuel consumption on the board), etc. Hence a signal which can be analogue or digital is taken and it can be directly processed by the sensor capturing the measurement in the input port, or it can be processed to transform it into an appropriate signal for the processor or it can be directly taken by the processor. This depends on the origin and type of input signal and the existing devices on the equipment for which the CO₂e emissions are being calculated. For example, in a modern car, the microprocessor itself that manages the vehicle electronics and intervenes in the final registration of the output data observed in the dashboard, can incorporate, along with its complementary devices, the software lines which calculate the CO₂e emissions from fuel consumption measured and reported on the board. In an aircraft, the processor could consider, among others, the fuel measurement, and after intermediate devices already installed in the aircraft, it ends up carrying information of interest to the passenger communication screen (not only of the CO₂e that is responsibility of each passenger but also information about compensations made by the airline and awareness campaigns), in addition to current reports on kilometres covered, distance to destination, altitude, airspeed, outside temperature, etc. The signal is transmitted electrically or with wireless connectivity to a conventional multi-transducer adapted for the proposed system, which receives such signal. It goes through the first blocks of the transducer (filters and signal modulators) responsible for processing and adapting these input signals, filter them and adapt them to the input setting of the central processor. The signal passes then to the processor containing the program or software that calculates, among other parameters, the CO₂e emissions. The processor has memories (volatile and non-volatile) for storing data and calculation values and a dock to synchronize the measurements with the cumulative records. The software device calculates the CO₂e emissions based on a formula that considers the consumption of energy resources and multiply it by the emission factors of carbon dioxide (CO₂), methane (CH₄) and nitrous oxide (N₂O) in basic CO₂e units (taking into account the respective global warming potentials) corresponding to the burning of fossil fuels or the emission factor of the electric grid to which the equipment, device or electric meter is connected. The generic calculation formula used to define CO₂e emissions can be expressed as follows:

E_{CO}_{₂}ₑ=Cᵢ×(FEᵢ^{CO}^{₂}+FEᵢ^{CH}^{₄}×PCG_{CH}_{₄}+FEᵢ^{N}^{₂}^{O}×PCG_{N}_{₂}_{O})=Cᵢ×FEᵢ^{CO}^{₂}^{e}

where E_{CO}_{₂}_{e=CO}₂e emission. Cᵢ=consumption of energy resource. FEᵢ^{CO}^{₂}=CO₂ emission factor related to energy resource. FEᵢ^{CH}^{₄}=CH₄ emission factor related to energy resource. FEᵢ^{N}^{₂}^{O}=N₂O emission factor associated to energy resource. PCG_{CH}_{₄}=global warming potential of CH₄. PCG_{N}_{₂}_{O}=global warming potential of N₂O. FEᵢ^{CO}^{₂}^{e}=CO₂e emission factor related to energy resource. The global warning potential is an index based on the radioactive properties of greenhouse gases that compares the potential impacts caused by the emission of each one of them in the climate system in relative terms, using CO₂ as the reference unit. When the amount of greenhouse gas emitted is multiplied by the global warming potential of gas, the resulting amount is expressed as CO₂e. Emission factors transform energy consumption in CO₂e emissions. Said factors may arise or be calculated from specific data of the energy resource supplier, from national values (for example, taken from the National Communications of the countries that have ratified the United Nations Framework Convention on Climate Change or taken as values by default from the most updated version of the Intergovernmental Panel on Climate Change guidelines for the national inventories of greenhouse gases in the case of fossil fuels or calculated from data of the interconnected grid related to electricity consumption whose CO₂e emissions are wished to be known). Once signals are sent out from the processor, they are transmitted to other systems through interfaces (source, filters, etc.), which may generate a digital signal on a board, screen, clock, etc. whether instantaneous or cumulative, or in an output port that sends the information, by means of a communication protocol, to a remote recording and processing central.

Having described and determined the nature of the invention, its scope and the way in which its fundamental idea can be put into practice, the following is stated as a proprietary invention:

1. DINAMIC SYSTEM OF INSTANTANEOUS COUNTING AND CUMULATIVE PERIODIC SPACE-TIME RECORD OF EQUIVALENT CARBON DIOXIDE EMISSIONS characterized by being composed of: a connection which takes the energy resource consumption data provided by the conventional measuring system installed in the device to be measured, taking a signal which can be either analogue or digital, and sends it to a multi-transducer, which in turn, processes and adjusts these signals, filters them and adapts them to the input setting of a processor with a software application allowing to calculate the equivalent carbon dioxide emissions related to that consumption, and which transmits the processed signals to other systems through interfaces generating digital data, instantaneous or cumulative, as well as to an output port which sends information, through a communication protocol, to a remote recording and processing central.

2. DINAMIC SYSTEM OF INSTANTANEOUS COUNTING AND CUMULATIVE PERIODIC SPACE-TIME RECORD OF EQUIVALENT CARBON DIOXIDE EMISSIONS, according to claim number one, characterized by the fact that the software device calculates the equivalent carbon dioxide emissions according to a formula which considers the energy resource consumption and multiplies it by the emission factors of carbon dioxide (CO₂), methane (CH₄) and nitrous oxide (N₂O) in basic CO₂e units (taking into account the respective global warming potentials) corresponding to the burning of fossil fuels or the emission factor of the electric grid to which the equipment, device or electric meter is connected.

3. DINAMIC SYSTEM OF INSTANTANEOUS COUNTING AND CUMULATIVE PERIODIC SPACE-TIME RECORD OF EQUIVALENT CARBON DIOXIDE EMISSIONS, according to claim number one, characterized by collecting carbon dioxide emission data for each device, vehicle or installation individually.

4. DINAMIC SYSTEM OF INSTANTANEOUS COUNTING AND CUMULATIVE PERIODIC SPACE-TIME RECORD OF EQUIVALENT CARBON DIOXIDE EMISSIONS, according to claim number one, characterized by the fact that it allows the data obtained from measurements to correlate with the time and place at which the events occur, which shall then be accumulated for a detailed analysis.

5. DINAMIC SYSTEM OF INSTANTANEOUS COUNTING AND CUMULATIVE PERIODIC SPACE-TIME RECORD OF EQUIVALENT CARBON DIOXIDE EMISSIONS, according to claim number one, characterized by transmitting data collected instantly to a processing central able to receive multiple individual data. 5) DINAMIC SYSTEM OF INSTANTANEOUS COUNTING AND CUMULATIVE PERIODIC SPACE-TIME RECORD OF EQUIVALENT CARBON DIOXIDE EMISSIONS, according to claim number one, characterized by using a methodology of analysis on particular data (“bottom-up” methodology) to reach general conclusions.
